(19) United States
(12) Patent Application Publication
(10) Pub. No.: US 2024/0266500 A1
(43) Pub. Date: Aug. 8, 2024

(54) APPARATUS AND METHOD FOR PRODUCTION OF SULFUR-HOST COMPOSITE MATERIALS

(71) Applicant: National University of Singapore, Singapore (SG)

(72) Inventors: Sergio Graniero Echeverrigaray, Singapore (SG); Vivek Nair, Singapore (SG); Antonio Helio de Castro Neto, Singapore (SG)

(73) Assignee: National University of Singapore, Singapore (SG)

(21) Appl. No.: 18/566,526

(22) PCT Filed: Jun. 2, 2022
(86) PCT No.: PCT/SG2022/050378

§ 371 Date: Dec. 1, 2023

(30) Foreign Application Priority Data
Jun. 2, 2021 (SG) 10202105832Q

(51) Int. Cl. H01M 4/36; H01M 4/136; H01M 4/60

(52) U.S. Cl. CPC H01M 4/362; H01M 4/136; H01M 4/602

(57) ABSTRACT

Disclosed herein is an apparatus suitable for preparing sulfur-host composite materials, comprising: a screw extruder comprising one or more heating zones, each comprising a heating element; a means or apparatus for providing an inert atmosphere or vacuum to the screw extruder; and an atomiser configured to receive a molten stream from the screw extruder and atomise the molten stream into an atomised stream, wherein the screw extruder is configured to generate a molten stream comprising molten sulfur and a solid particulate host material when in use.

### FIELD OF THE INVENTION

The invention relates to an apparatus for the production of sulfur-host composite materials; to a method for the production of sulfur-host composite materials, particularly having a quasi-spherical shape; to a core-shell sulfur-host composite microparticle/nanoparticle; and to a method of forming an electrode using the sulfur-host composite material.

### BACKGROUND

The thermal processing of compositions of elemental sulphur with carbon-based materials as host is a widely used synthesis technique for the production of carbon-sulfur composites. The technique is popular due to its low cost and scalability, and the usefulness of sulfur in the composition of electrodes for batteries due to its high theoretical capacity.

However, a problem associated with the use of sulfur-based electrodes in batteries is that sulfur may dissolve in the electrolyte, leading to a short battery life. In order to overcome this problem, sulfur-host composite materials have been used, in which the sulfur forms a covalent (or other strong) bond to the host-material, thereby preventing dissolution of sulfur.

However, there is still a need for sulfur-host composite materials that provide improved energy density and other electrochemical properties.

### SUMMARY OF THE INVENTION

The inventors have surprisingly found that apparatus and methods described herein enable the preparation of sulfur-host materials having improved properties.

The invention provides an apparatus suitable for the production of sulfur-host composite materials comprising:
a screw extruder comprising one or more heating zones, each comprising a heating element;
a means or apparatus for providing an inert atmosphere or vacuum to the screw extruder; and
an atomiser configured to receive a molten stream from the screw extruder and atomise the molten stream into an atomised stream,
wherein the screw extruder is configured to generate a molten stream comprising molten sulfur and a solid particulate host material when in use.

Advantageously, the use of an atomiser enables the production of quasi-spherical particles containing a shell of sulfur encapsulating a core of particulate host material. For the following reasons, these particles are advantageous compared to irregular shaped milled particles that are produced by the traditional method of milling an extrudate.
Electrodes formed from quasi-spherical particles have a larger pore volume and higher surface area, allowing high sulfur utilization in a resulting electrode. This improves the ionic conductivity by allowing the electrolyte to access a larger surface area of the active sulfur material, thereby improving the energy density and rate performance;
The quasi-spherical form assists the immobilization and conversion kinetics of polysulfides within the spherical matrix enhanced by the affinity towards the host material. This helps to retards or avoid polysulfide shuttling, which is one of the biggest issues associated with the electrochemical cycling of sulfur electrode materials.
The quasi-spherical form provides sufficient space to accommodate the necessary volume expansion during electrochemical cycling of sulfur electrode materials.

The invention also provides a method for forming quasi-spherical particles of a sulfur-host composite material comprising the steps:
(i) providing a particulate host material and elemental sulfur to a screw extruder;
(ii) mixing the particulate host material and elemental sulfur in the screw extruder at a temperature of from 115 to 450° C. to create a stream comprising molten sulfur and a solid particulate host material;
(iii) passing the stream comprising molten sulfur and solid particulate host material through an atomiser to form an atomised stream comprising a plurality of particles formed from solid particulate host material surrounded by molten sulfur; and
(iv) cooling the atomised stream to form solid particles comprising a particulate host material core and a shell formed from elemental sulfur, which particles have a quasi-spherical shape.

The invention also provides a core-shell microparticle or nanoparticle comprising:
a core formed from a host material; and
a shell formed from elemental sulfur,
wherein the microparticle or nanoparticle has a quasi-spherical shape.

The invention also provides a method for forming an electrode comprising the steps:
(i) providing a particulate host material and elemental sulfur to a screw extruder;
(ii) mixing the particulate host material and elemental sulfur in the screw extruder at a temperature of from 115 to 450° C. to create a stream comprising molten sulfur and solid particulate host material;
(iii) cooling the stream comprising molten sulfur and solid particulate host material to a temperature of from 115 to 135° C.; and
(iv) extruding the cooled stream from step (iii) to form a self-standing electrode.

The apparatus and methods of the invention allow for the continuous production of sulfur-host composite materials with high-yield and low processing costs.

### BRIEF DESCRIPTION OF THE FIGURES

FIG. 1 shows an example of an apparatus setup according to the invention.

FIG. 2 shows a detailed view of an atomiser that may be useful in the invention.

FIG. 3 shows how extrudate may be pressed into a current collector between rollers

### DETAILED DESCRIPTION OF THE INVENTION

The invention provides an apparatus suitable for the production of sulfur-host composite materials comprising:
a screw extruder comprising one or more heating zones, each comprising a heating element;
a means or apparatus for providing an inert atmosphere or vacuum to the screw extruder; and
an atomiser configured to receive a molten stream from the screw extruder and atomise the molten stream into an atomised stream,
wherein the screw extruder is configured to generate a molten stream comprising molten sulfur and a solid particulate host material when in use.

As mentioned above, the inclusion of an atomiser in the apparatus enables the production of quasi-spherical particles containing a shell of sulfur encapsulating a core of particulate host material, with the attendant advantages noted hereinbefore.

In embodiments herein, the word “comprising” may be interpreted as requiring the features mentioned, but not limiting the presence of other features. Alternatively, the word “comprising” may also relate to the situation where only the components/features listed are intended to be present (e.g. the word “comprising” may be replaced by the phrases “consists of” or “consists essentially of”). It is explicitly contemplated that both the broader and narrower interpretations can be applied to all aspects and embodiments of the present invention. In other words, the word “comprising” and synonyms thereof may be replaced by the phrase “consisting of” or the phrase “consists essentially of” or synonyms thereof and vice versa.

The phrase “consists essentially of” and its pseudonyms may be interpreted herein to refer to a material where minor impurities may be present. For example, the material may be greater than or equal to 90% pure, such as greater than 95% pure, such as greater than 97% pure, such as greater than 99% pure, such as greater than 99.9% pure, such as greater than 99.99% pure, such as greater than 99.999% pure, such as 100% pure.

As used herein, a sulfur-host composite material is a material comprising sulfur and a host material. The sulfur may be in the form of elemental sulfur that is bound at its surface to the host material (e.g. by a covalent bond and/or electrostatic interactions). The host material may be any suitable material which it onto/into may be desirable t coat/adsorb/impregnate/diffuse sulfur. For example, suitable host materials that may be mentioned herein include electrically conductive materials, semi-conducting materials and insulating materials. Examples of specific host materials include one or more of the group consisting of Fe, Zn, Mn, Ti, W, Mo, Cr, Cu, Sn, Te, Gd, Ge, Lu, Co, Tb, Ru, Nb, V, Zr, Si, P, C, B, Al, Mg, Ca, an oxide thereof, and a conductive polymer. Particular metal oxides that may be useful as host materials for sulfur include RuO₂, Ti₄O₇, and MnO₂, while particular conductive polymers that may be useful as host materials include polyaniline (PANI).

Carbon may be useful as a host material, particularly when in the form of one or more carbon nanomaterials. When used herein, the term “carbon nanomaterial” may refer to any suitable material that has suitable size range. For example, in certain embodiments of the invention that may be disclosed herein, the carbon nanomaterial may have an average hydrodynamic diameter of from 1 to 1,000 nm, such as from 100 to 400 nm, such as from 1 to 100 nm. In more particular embodiments of the invention that may be mentioned herein, the term “carbon nanomaterial” may refer to a “carbon nano-object” as defined under the standard “ISO/TS 80004-3:2020(en) Nanotechnologies—Vocabulary—Part 3: Carbon nano-objects”, which is hereby incorporated herein by reference.

Examples of suitable carbon nanomaterials include, but are not limited to carbon nanotubes, carbon nanofibers, fullerenes, graphenes, graphene oxides, nanographites, carbon blacks, acetylene blacks, thermal blacks, mesoporous carbons, carbon quantum dots, graphene quantum dots and combinations thereof. In particular embodiments that may be mentioned herein, the carbon nanomaterial may be a graphene and/or a carbon black. These materials may be as defined in the standard “ISO/TS 80004-3:2020(en) Nanotechnologies—Vocabulary—Part 3: Carbon nano-objects”. In particular examples that may be mentioned herein, the graphene may be in the form of graphene nanoplatelets and the carbon black may be in the form of Ketjen black. Graphene nanoplatelets as used herein may take the definition of the standard: ISO/TS 80004-13:2017. Suitable graphene nanoplatelets may be commercially available.

In certain embodiments of the invention that may be mentioned herein, the carbon nanomaterial material may further comprise halogen atoms attached to the carbon nanomaterial. The halogen atoms may be attached to active-sites in the carbon nanomaterial. Examples of active sites in the carbon nanomaterial may include, but are not limited to surfaces, edges, defects (e.g. pores), and interlayers.

As will be appreciated by a person skilled in the art, the form of the host material is not particularly limited. Suitable forms of host material include, for example, sheets, fibres, foams, tubes, rods, spheres, and particles, each of which may have a porous or solid structure.

A skilled person will be familiar with other materials that may be suitable host materials for sulfur.

As will be appreciated by a person skilled in the art, the screw extruder may be any suitable type of screw extruder. In embodiments of the invention that may be mentioned herein, the screw extruder may be selected from the group consisting of a twin screw counter-rotating extruder, twin screw co-rotating extruder, single screw extruder, single screw reciprocating extruder, ring screw extruder, or any other device that promotes the melting and transport to produce the desired composite.

The screw extruder comprises one or more heating zones, which ensure that the sulfur passing through the screw extruder melts to form a molten sulfur stream. This allows the host material (in the form of a particulate host material) to become dispersed within the molten sulfur, and for the resulting stream to be passed through a nozzle.

The screw extruder may also comprise one or more additional zones. For example, the screw extruder may comprise one or more cooling zones situated downstream from the one or more heating zones, each comprising a cooling element. The cooling zones may advantageously reduce the temperature of the molten sulfur to increase its viscosity before being passed to the atomiser. For the avoidance of doubt, a cooling zone is not an essential element of the apparatus of the invention, because the resulting particles may be cooled in a solidification chamber. The screw extruder may also comprise other zones, for example zones for receiving and heating a feed, and mixing zones for mixing a feed to provide a homogeneous mixture. The mixing zones may comprise high-shear zones (e.g. comprising mixing screw elements) for deagglomeration of host materials that may be provided in an agglomerated form, such as graphene nanoplatelets and/or expanded graphite. The screw extruder may also comprise a compression zone, which compresses the material within the extruder to provide the necessary pressure to force the molten material through the nozzle at a sufficient rate to atomize the molten extrudate.

The residence time of the materials within the screw extruder may be any appropriate time, for example any time that is sufficient for the sulfur to adsorb/impregnate/diffuse onto/into the host material. Suitable residence times will be known to a person skilled in the art, and may in some embodiments be greater than 10 seconds. As will be appreciated by a person skilled in the art, porous and hollow materials such as carbon black and ketjen black may require longer residence times.

The screw extruder comprises a means or apparatus for providing an inert atmosphere (e.g. Ar, He, or N₂) or vacuum to the screw extruder. The inert atmosphere or vacuum is desirable to prevent oxidation of the sulfur during heating, since it is desirable that a sulfur-host composite material comprises elemental sulfur. Since the purpose of the inert atmosphere or vacuum is to prevent (or at least minimise) oxidation of the sulfur, the exact way in which the inert atmosphere or vacuum is achieved is not particularly important to the invention, and it will be readily apparent to a person skilled in the art how to implement an inert atmosphere or vacuum in a screw extruder. Suitable examples of a means or apparatus for providing an inert atmosphere or vacuum to the screw extruder include an inlet/outlet for supplying and removing an inert gas, and a vacuum pump.

Therefore, in some embodiments of the invention that may be mentioned herein, the means for providing an inert atmosphere or vacuum comprises either:
an inlet, an outlet and a fluid flow path therebetween suitable for providing an inert gas atmosphere to the screw extruder; or
a vacuum pump suitable for creating a vacuum in the screw extruder

The apparatus of the invention comprises an atomiser configured to receive a molten stream from the screw extruder and atomise the molten stream into an atomised stream. This is advantageous because the atomiser enables the production of quasi-spherical particles, rather than irregular particles that may be produced by milling or other processing of an extrudate. The nature of the atomiser is not particularly limited, and any suitable atomiser may be used in accordance with the invention. A skilled person will appreciate that the atomiser may comprise one or more nozzles. Thus, in some embodiments of the invention that may be mentioned herein, the atomiser may be selected from one or more of the group consisting of a rotary atomizer, a pressure nozzle, an ultrasonic atomizer, or more particularly, a two fluid pneumatic nozzle. As explained herein, the use of an atomizer advantageously allows the production of the sulfur-host composite material in quasi-spherical form. The quasi-spherical form is highly advantageous for use in forming sulfur-based electrodes, for the reasons explained above. A person skilled in the art will understand that the term “quasi-spherical” as used herein means that the particles may be spherical, approximately spherical, or have sphere-like shape. In particular, in some embodiments of the invention a quasi-spherical particle may be a particle that is more spherical than one that is generated by milling of a larger mass of material/particle (which milling produces particles having an irregular surface). For example, such quasi-spherical particles may be generated by an atomiser. A person skilled in the art will also understand that the term “quasi-spherical” is commonly used in the art to describe nano- and micro-particles because it is not always possible to determine whether or not they have an exactly spherical shape.

The atomiser may comprise, or be preceded by, a pump configured to increase the flow of feed through the atomiser. This may help to produce a consistent uniform atomised stream.

The ratio of host material to elemental sulfur may be, for example, from 3:7 to 1:99, such as from 1:4 to 3:97, e.g. from 3:17 to 1:19. In other words, the sulfur-host material composite may comprise from 1-30 wt. % host material and 70-99 wt. % elemental sulfur, such as 3-25 wt. % host material and 75-97 wt. % elemental sulfur, e.g. 5-15 wt. % host material and 85-95 wt. % elemental sulfur.

Sulfur-host composite materials produced according to the invention may be useful as, or in, electrodes for batteries. Such electrodes may have advantageously high capacity over many battery cycles, and be highly resistant to dissolution of sulfur into the electrolyte.

In some embodiments of the invention, the apparatus may comprise a solidification chamber configured to receive the atomised stream produced by the atomiser. The atomised stream produced by the atomiser may comprise a solid particulate host material core, and a shell of molten sulfur. The solidification chamber may assist the solidification of the sulfur shell, for example by providing a cooling gas stream to the atomised stream. This may be achieved by the use of a gas inlet for providing a cooling gas stream to the solidification chamber to solidify the atomised stream. A skilled person will appreciate that other means of cooling the atomised stream may also be used in addition to, or instead of, a cooling gas stream. For example, in some embodiments of the invention that may be mentioned herein, the apparatus may comprise a cooling jacket surrounding the solidification chamber, the cooling jacket configured to cool the solidification chamber.

The solidification chamber may also comprise, or be associated with, a solid-gas separator for isolating the solidified atomised stream.

Thus, in some embodiments of the invention that may be mentioned herein, the apparatus may further comprise:
a solidification chamber configured to receive the atomised stream produced by the atomiser;
a gas inlet for providing a cooling gas stream to the solidification chamber to solidify the atomised stream; and
a first solid-gas separator for isolating the solidified atomised stream

In some embodiments of the invention that may be mentioned herein, the apparatus may further comprise a gas recirculation and solids-separation system connected to the solidification chamber. The use of a gas-recirculation system enables the cooling gas stream to be recirculated, thereby reducing the amount of cooling gas that is required to be used.

This may be advantageous when the cooling gas is an inert gas. The solids-separation system improves the recovery efficiency of the solidified atomised stream, particularly when a cooling gas is used. This is because some particles of the atomised stream will be carried by the cooling gas stream and around the gas recirculation system.

Therefore, in some embodiments of the invention that may be mentioned herein, the gas recirculation and solids-separation system may comprise:
one or more additional solid-gas separators for isolating a solidified sulfur-host composite material,
a first fluid connection from the solidification chamber to the one or more additional solid-gas separators, and
a second fluid connection from the one or more additional solid-gas separators to the solidification chamber.

In some embodiments of the invention that may be mentioned herein, the gas recirculation and solids-separation system, and the solidification chamber, may together form a circulating fluid flow path comprising:
the first fluid connection;
the one or more additional solid-gas separators;
the second fluid connection; and
the solidification chamber.

The solidification chamber, when present, may comprise a window or camera that allows inspection of the interior of the solidification chamber.

In some embodiments of the invention that may be mentioned herein, the one or more additional solid-gas separators may comprise two or three additional solid-gas separators, such as two additional solid-gas separators. The one or more additional solid-gas separators may be selected from the group consisting of a cyclone separator, an electrostatic separator and a system comprising one or more filters and traps

When a gas inlet configured to provide a cooling gas stream is present, it may be configured to provide a cooling gas stream in substantially the opposite direction to a flow of the atomised stream out of the atomiser. Without being bound by theory, this is believed to provide an improved cooling effect to the atomised stream.

In some embodiments of the invention that may be mentioned herein, the solidification chamber may be formed from a corrosion resistant material, such as a corrosion resistant material selected from the group consisting of corrosion resistant metals (e.g. stainless steel), ceramics (e.g. glass ceramics, glasses, porcelains), polymers, polymer composites (e.g. glass fibre), and a combination thereof (e.g. a combination of metals and ceramics such as separate regions formed from metals and ceramics, metals coated with ceramics, and ceramics coated with metals). A skilled person would understand how these materials may be used in combination, such as different components/regions/parts formed from separate materials, or one material coated on top of another material.

It is advantageous for the solidification chamber to have an interior surface that is resistant to the adhesion of the atomised stream. This improves the recovery of the solidified atomised stream. Therefore, in some embodiments of the invention that may be mentioned herein, the solidification chamber comprises an interior coating having:
a mirror finish; and/or
a water contact angle of greater than 90°.

The apparatus may comprise one or more temperature sensors (e.g. thermocouples) for monitoring the temperature of the atomiser, solidification chamber and/or gas recirculation system. A skilled person will appreciate that it is advantageous to monitor the temperature of these components to ensure that the sulfur is maintained in the desired state (i.e. solid or liquid).

In some embodiments of the invention that may be mentioned herein, the apparatus may comprise a conditioning chamber located upstream from the screw extruder, the conditioning chamber being configured to mix, mill or otherwise process a feed (e.g. by ball mixing). This may help to ensure that the feed entering the screw extruder is in a form that is able to be more easily processed by the screw extruder. A specific example of a use of a conditioning chamber may be to process the particle size/shape of a host material before entry to the screw extruder.

Further elements that may be included in the apparatus of the invention include drying chambers and acclimatization chambers (vaccum or atmosphere inertization), can be employed. These may be useful to improve the purity of the final product.

The invention also provides a method for forming quasi-spherical particles of a sulfur-host composite material comprising the steps:
(i) providing a particulate host material and elemental sulfur to a screw extruder;
(ii) mixing the particulate host material and elemental sulfur in the screw extruder at a temperature of from 115 to 450° C. to create a stream comprising molten sulfur and a solid particulate host material;
(iii) passing the stream comprising molten sulfur and solid particulate host material through an atomiser to form an atomised stream comprising a plurality of particles formed from solid particulate host material surrounded by molten sulfur; and
(iv) cooling the atomised stream to form solid particles comprising a particulate host material core and a shell formed from elemental sulfur, which particles have a quasi-spherical shape.

As will be appreciated by a person skilled in the art, the apparatus of the invention discussed herein may be useful in the methods of the invention, and features of the invention described above with relation to the apparatus of the invention apply equally to the method of the invention. For example, the host material and ratio of host material to elemental sulfur may be as defined hereinabove.

The method provides solid particles (which are typically microparticles or nanoparticles) comprising a particulate host material core and a shell formed from elemental sulfur. These particles may then be processed into a composite material comprising crystalline sulfur and homogeneously dispersed host material. In an embodiment of the invention that may be mentioned herein, the composite material may comprise at least 45 wt. % α-sulfur (e.g. at least 60 wt. %, at least 70 wt. %, at least 80 wt. % or at least 90 wt. %) α-sulfur.

Thus, the particles comprising a particulate host material core and a shell formed from elemental sulfur are microparticles or nanoparticles.

In some embodiments of the invention that may be mentioned herein, the method may comprise a post-processing step of processing the solid particles into a composite material comprising crystalline sulfur and homogeneously dispersed host material.

In some embodiments of the invention that may be mentioned herein, wherein step (ii) may be performed at a temperature of from 130 to 250° C., for example from 150 to 180ºC.

In some embodiments of the invention that may be mentioned herein, the method may comprise a preliminary step of mixing the particulate host material and the elemental sulfur to form a homogeneous mixture. As will be appreciated by a person skilled in the art, such a step may be performed in a conditioning chamber as disclosed herein.

The invention also provides a core-shell microparticle or nanoparticle comprising:
a core formed from a host material; and
a shell formed from elemental sulfur,
   wherein the microparticle or nanoparticle has a quasi-spherical shape.

As will be appreciated by a person skilled in the art, such a core-shell microparticle or nanoparticle may be produced by the method according to the invention, but may alternatively be produced by a different method. In the core-shell microparticle or nanoparticle according to the invention, the host material may be as defined herein in relation to the apparatus and/or method of the invention.

The invention also provides an electrode comprising the core-shell microparticle or nanoparticle according to the invention.

The invention also provides a method for forming an electrode comprising the steps:
(i) providing a particulate host material and elemental sulfur to a screw extruder;
(ii) mixing the particulate host material and elemental sulfur in the screw extruder at a temperature of from 115 to 450° C. to create a stream comprising molten sulfur and solid particulate host material;
(iii) cooling the stream comprising molten sulfur and solid particulate host material to a temperature of from 115 to 135° C.; and
(iv) extruding the cooled stream from step (iii) to form a self-standing electrode.

The extrudate formed in step (iv) is suitable for use as a self-standing electrode, but may also be pressed into a current collector (or between two current collectors) to form an electrode. Suitable current collectors materials include materials that have a higher electronic conductivity than the sulfur-host composite material.

Examples of materials include metals such as copper, nickel, chromium, tungsten, metal nitrides, metal oxides, metal carbides, carbon, conductive polymers, and combinations thereof. In some implementations, the current collector layer can be a nanomaterial network, including nanofiber, nanowire, and nanotube network. Further examples of nanomaterial networks can include networks of spheres, cones, rods, tube, wires, arcs, belts, saddles, flakes, ellipsoids, meshes, laminate foams, tapes, and combinations thereof. The network may be a non-uniform, continuous film in some implementations. That is, a film provides one or more continuous conductive pathways while allowing electrochemical species transport through the film. Electronically conductive binders can also be added to any of the current collectors described herein. In addition, combinations of materials, as described herein, can be used to form a current collector layer.

Pressing of the extrudate into a current collector or between two current collectors may be performed between rollers, e.g. by tape-casting or coextrusuion.

In this method of the invention, the extrudate is preferably cuboid-shaped, i.e. the extruder preferably has a square-shaped nozzle.

Such a method may be performed using an apparatus analogous to the apparatus disclosed herein, which does not comprise an atomiser. Where technically appropriate, any feature of the apparatus or methods of the invention described above apply equally to this method of the invention. For example:
step (ii) may be performed at a temperature of from 130 to 250° C. (e.g. from 150 to 180° C.);
the method may comprise a preliminary step of milling mixing the particulate host material and the elemental sulfur to form a homogeneous mixture;
the host material may be as described herein; and
the ratio of host material to sulfur provided to the screw extruder may be as described herein.

The methods and apparatus of the invention are described in detail below with reference to the Figures.

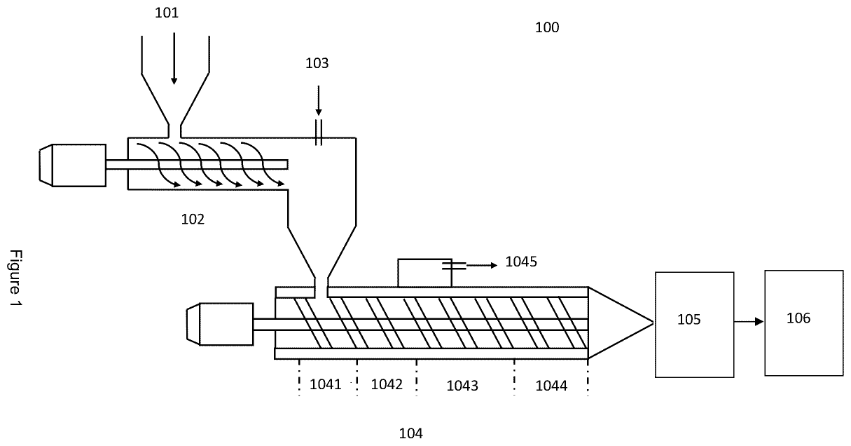

FIG. 1 shows an apparatus 100. A feed comprising sulfur and a solid host material may be fed into a conditioning chamber 102, e.g. via a hopper 101. Conditioning chamber 102 is configured to mix, mill, or otherwise process the feed. The feed comprises sulfur and a host material as described herein, such as 30 wt. % graphene nanoplatelets as the host material, and 70 wt. % elemental sulfur. In some embodiments, the conditioning chamber 102 may mix the feed to form a homogeneous mixture (e.g. by ball mixing or using shear and transport tools). The conditioning chamber 102 may comprise a gas inlet 103 to provide an inert atmosphere to the conditioning chamber, which may acclimatise the raw materials for the removal of water or saturation of the atmosphere with inert gases.

The conditioned feed from the conditioning chamber 102 may then pass into the screw extruder 104, which may comprise four zones 1041, 1042, 1043 and 1044. The first zone 1041 is a feeding and heating zone, which receives the feed and heats it. The second zone 1042 is a melting zone, which heats the feed to a temperature high enough to melt the sulfur in the feed (but generally not the host material), such as a temperature of around 165° C. The third zone 1043 is a mixing zone that ensures the molten sulfur and solid host material are fully mixed. The third zone may provide high shear mixing to deagglomerise materials in need of such treatment, e.g. graphene nanoplatelets. The fourth zone 1044 may represent an optional cooling zone, which may be present to cool the mixed feed to increase its viscosity before being passed out of the screw extruder 104 (e.g. a temperature of from 115 to 130° C.). In alternative embodiments, the fourth zone 1044 may represent a compression zone for providing the necessary pressure to force molten material through the nozzle at a sufficient rate to ensure atomisation occurs. The screw extruder 104 may comprise a means or apparatus 1045 for providing an inert atmosphere or vacuum to the screw extruder, particularly to the second and third zones discussed in relation to this embodiment. The means or apparatus may comprise a gas inlet/outlet or a vacuum pump. The molten stream from the screw extruder may then to an atomiser 105, which is configured to receive the molten stream and atomise the molten stream into an atomised stream, and optionally to a solidification chamber 106.

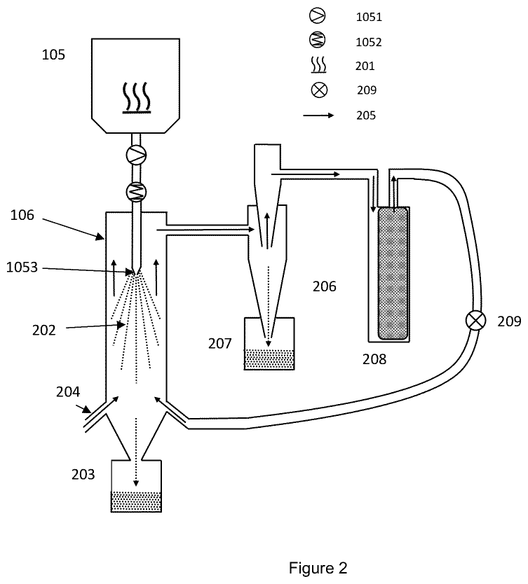

The atomiser 105 and solidification chamber 106 are shown in more detail in FIG. 2. The molten stream 201 from the screw extruder may be received by the atomiser 105, which may comprise a pump 1051, heater 1052 and nozzle 1053. The molten stream 201 (which comprises molten sulfur and solid particulate host material) passes through the nozzle 1053 to form an atomised stream 202, which atomised stream comprises particles having a shell of molten sulfur and a core of solid particulate host material. The atomised stream 202 rapidly cools after atomisation, solidifying the sulfur to form quasi-spherical micro- or nano-particles having a shell formed from elemental sulfur and a core of host material. These solid micro- or nano-particles may be collected, e.g. in a solid-gas separator 203.

The solidification chamber may also comprise a gas inlet 204 for providing a cooling gas stream (depicted by arrows 205) to the solidification chamber, which cooling gas stream helps to solidify the atomised stream 202.

The performance of the solidification chamber may be improved by the use of a gas recirculation and solids-separation system 206. This may comprise one or more additional solid-gas separators 207 and 208, each of which may be, for example, a cyclone separator, an electrostatic separator or a system comprising one or more filters and traps. The gas recirculation and solids-separation system 206 may also comprise an aspirator 209 for improving gas flow around the gas recirculation and solids-separation system 206. Some of the atomised stream 202 will flow with the cooling gas stream 205 into the gas recirculation and solids-separation system 206, and may be collected by the one or more additional solid-gas separators 207 and 208. Cooling gas 205 is circulated around the gas recirculation and solids-separation system 206 and will re-enter the solidification chamber 106 where it will again assist the cooling and solidification of the atomised stream 202.

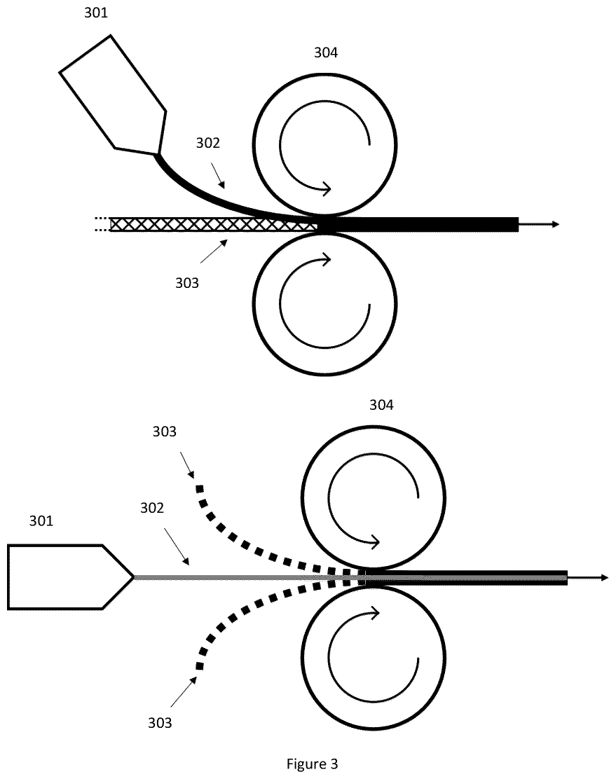

Pressing of extrudate into a current collector or between two current collectors may be performed between rollers, e.g. by tape-casting or coextrusuion as shown in FIG. 3. In FIG. 3, an extruder 301 forms an extrudate 302 which is pressed into a current collector 303 by rollers 304. FIG. 3, top, shows a setup involving a single layer of current collector, while FIG. 3, bottom, shows a setup involving two layers of current collector.

The collected solid micro/nanoparticles may be further processed as disclosed herein.

1. An apparatus suitable for the production of sulfur-host composite materials comprising:
a screw extruder comprising one or more heating zones, each comprising a heating element;
a means or apparatus for providing an inert atmosphere or vacuum to the screw extruder; and
an atomiser configured to receive a molten stream from the screw extruder and atomise the molten stream into an atomised stream,
wherein the screw extruder is configured to generate a molten stream comprising molten sulfur and a solid particulate host material when in use.

2. The apparatus according to claim 1, further comprising:
a solidification chamber configured to receive the atomised stream produced by the atomiser;
a gas inlet for providing a cooling gas stream to the solidification chamber to solidify the atomised stream; and
a first solid-gas separator for isolating the solidified atomised stream.

3. The apparatus according to claim 2, further comprising a gas recirculation and solids-separation system connected to the solidification chamber, the gas recirculation and solids-separation system comprising:
one or more additional solid-gas separators for isolating a solidified sulfur-host composite material,
a first fluid connection from the solidification chamber to the one or more additional solid-gas separators, and
a second fluid connection from the one or more additional solid-gas separators to the solidification chamber.

4. The apparatus according to claim 3, wherein the gas recirculation and solids-separation system, and the solidification chamber, together form a circulating fluid flow path comprising:
the first fluid connection;
the one or more additional solid-gas separators;
the second fluid connection; and
the solidification chamber.

5. The apparatus according to claim 4, wherein the one or more additional solid-gas separators comprises two additional solid-gas separators.

6. The apparatus according to claim 3, wherein the one or more additional solid-gas separators comprise a solid-gas separator selected from the group consisting of a cyclone separator, an electrostatic separator and a system comprising one or more filters and traps.

7. The apparatus according to claim 2, wherein the gas inlet is configured to provide a cooling gas stream in substantially the opposite direction to a flow of the atomised stream out of the atomiser.

8. The apparatus according to claim 2, wherein the solidification chamber is formed from a corrosion resistant material, and a combination thereof.

9. The apparatus according to claim 2, wherein the solidification chamber comprises an interior coating having:
a mirror finish; and/or
a water contact angle of greater than 90°.

10. The apparatus according to claim 2, further comprising a cooling jacket surrounding the solidification chamber, the cooling jacket configured to cool the solidification chamber.

11. (canceled)

12. The apparatus according to claim 2, further comprising one or more thermocouples for monitoring the temperature of the atomiser, solidification chamber and/or the gas recirculation system.

13. (canceled)

14. (canceled)

15. (canceled)

16. A method for forming quasi-spherical particles of a sulfur-host composite material comprising the steps:
(i) providing a particulate host material and elemental sulfur to a screw extruder;
(ii) mixing the particulate host material and elemental sulfur in the screw extruder at a temperature of from 115 to 450° C. to create a stream comprising molten sulfur and a solid particulate host material;
(iii) passing the stream comprising molten sulfur and solid particulate host material through an atomiser to form an atomised stream comprising a plurality of particles formed from solid particulate host material surrounded by molten sulfur; and
(iv) cooling the atomised stream to form solid particles comprising a particulate host material core and a shell formed from elemental sulfur, which particles have a quasi-spherical shape.

17. The method according to claim 16, wherein the particles comprising a particulate host material core and a shell formed from elemental sulfur are microparticles or nanoparticles.

18. The method according to claim 16, wherein step (ii) is performed at a temperature of from 130 to 250° C., preferably from 150 to 180° C.

19. The method according to claim 16, comprising:
(a) a preliminary step of mixing the particulate host material and the elemental sulfur to form a homogeneous mixture; and/or
(b) a post-processing step of processing the solid particles into a composite material comprising crystalline sulfur and homogeneously dispersed host material.

20. The method according to claim 16, wherein the particulate host material is selected from one or more of the group consisting of Fe, Zn, Mn, Ti, W, Mo, Cr, Cu, Sn, Te, Gd, Ge, Lu, Co, Tb, Ru, Nb, V, Zr, Si, P, C, B, Al, Mg, Ca, an oxide thereof, and a conductive polymer.

21. The method according to claim 16, wherein the ratio of host material to elemental sulfur provided to the screw extruder is from 3:7 to 1:99, optionally from 1:4 to 3:97, such as from 3:17 to 1:19.

22. The method according to claim 16, wherein step (iv) is performed in a solidification chamber, and where the screw extruder, atomiser and solidification chamber are part of an apparatus,
wherein the apparatus comprises:
the screw extruder comprising one or more heating zones, each comprising a heating element;
a means or apparatus for providing an inert atmosphere or vacuum to the screw extruder; and
the atomiser configured to receive a molten stream from the screw extruder and atomise the molten stream into an atomised stream,
wherein the screw extruder is configured to generate a molten stream comprising molten sulfur and a solid particulate host material when in use.

23. A core-shell microparticle or nanoparticle comprising:
a core formed from a host material; and
a shell formed from elemental sulfur,
wherein the microparticle or nanoparticle has a quasi-spherical shape.

24. (canceled)

25. (canceled)

26. An electrode comprising the core-shell microparticle or nanoparticle according to claim 23.

27. A method for forming an electrode comprising the steps:
(i) providing a particulate host material and elemental sulfur to a screw extruder;
(ii) mixing the particulate host material and elemental sulfur in the screw extruder at a temperature of from 115 to 450° C. to create a stream comprising molten sulfur and solid particulate host material;
(iii) cooling the stream comprising molten sulfur and solid particulate host material to a temperature of from 115 to 135° C.; and
(iv) extruding the cooled stream from step (iii) to form a self-standing electrode.

28. (canceled)

29. (canceled)

30. (canceled)

31. (canceled)
